(19) United States
(12) Patent Application Publication
(10) Pub. No.: US 2019/0346340 A1
(43) Pub. Date: Nov. 14, 2019

(54) AN APPARATUS AND METHOD FOR INSPECTING COILED TUBING

(71) Applicant: Intelligent Wellhead Systems Inc., Sturgeon County (CA)

(72) Inventors: Bradley Robert Martin, Red Deer (CA); Aaron Mitchell Carlson, Lake Country (CA)

(73) Assignee: Intelligent Wellhead Systems Inc., Sturgeon County, AB (CA)

(21) Appl. No.: 16/482,468

(22) PCT Filed: Apr. 18, 2018
(86) PCT No.: PCT/CA2018/050465

§ 371 Date: Jul. 31, 2019

Related U.S. Application Data
(60) Provisional application No. 62/486,816, filed on Apr. 18, 2017.

(51) Int. Cl. G01M 5/00; E21B 47/00; E21B 33/06

(52) U.S. Cl. CPC G01M 5/0091; E21B 47/00; E21B 19/08; G01M 5/0033; G01M 5/0025; E21B 33/06

(57) ABSTRACT

Embodiments of the present disclosure relate to a coiled-tubing system, a coiled tubing inspection tool and methods for using same. The system comprises coiled tubing that is wound about a coiled tubing reel and a coiled tubing injector head that is connected to an oil-and-gas well above a pressurized zone. The coiled-tubing system also includes the inspection tool that is connected to the well within the pressurized zone. The inspection tool is configured to generate a magnetic field and to detect changes in the magnetic field as a section of coiled tubing approaches, moves through and moves away from the inspection tool. Detecting changes in the magnetic field may be indicative of a damaged section of the coiled tubing.

### TECHNICAL FIELD

This disclosure generally relates to oil-and-gas operations. In particular, the disclosure relates to an apparatus and method for inspecting coiled tubing.

### BACKGROUND

Coiled tubing is a continuous length of flexible, metal-walled tubing that can be used in various oil-and-gas operations. Coiled tubing can be stored and transported on a reel. During well interventions, the coiled tubing is inserted into an oil-and-gas well to perform any of fracking, milling, sand cleanouts or perforating. At least one benefit of coiled tubing over other known intervention methods, such as slick line and wire line, is that coiled tubing can be used to conduct pressurized fluids down into the well. Also, coiled tubing can be pushed downhole, which allows easier access to deviated or horizontal sections of a well that slick line and wire line cannot access easily.

Coiled tubing can also be used in drilling operations. At least one advantage of coiled tubing over other known drilling methods is that there are no connections to be made as there is with jointed tubing and, therefore, it is faster to move sections of the coiled tubing into or out from the well bore than jointed-tubing drill strings.

The integrity of coiled tubing can become compromised during normal use. For example, coiled tubing can become damaged during any of: being unwound from the reel, use during a well intervention or drilling operation downhole, being rewound onto the reel, during transport or any combinations thereof. Coiled tubing may also be damaged while it is exposed to the harsh down-hole environment of an oil-and-gas well. Regardless of the cause, the damage may be embodied by perforations, dents or otherwise weakened areas in the coiled tubing's metal wall. This damage can result in leaks, pressure loss, fluid loss and in some instances the coiled tubing may break. If the coiled tubing breaks while downhole, equipment that is connected to the coiled tubing can be lost as can any fluids that are being conducted through the coiled tubing. Broken coiled-tubing and lost equipment causes downtime at the well and often requires recovery operations, both of which are costly.

### SUMMARY

Some embodiments of the present disclosure relate to a coiled-tubing system for inserting and withdrawing coiled tubing into a well that has a pressure-containment section. The system comprises coiled tubing that is windable about a coiled tubing reel. The system also comprises a coiled tubing injector head that is connected to the well above the pressure-containment section. The system also comprises an inspection tool that is connected to the well within the pressure-containment section. The inspection tool is configured to generate a magnetic field and to detect one or more changes in the magnetic field as a section of coiled tubing approaches, passes through and moves away from the inspection tool.

Some embodiments of the present disclosure relate to a coiled-tubing inspection tool that comprises a body, one or more magnets and one or more sensors. The body defines a central passageway that is configured to receive coiled tubing therethrough. The one or more magnets that are configured to generate a magnetic field that extends at least partially across the central passageway. The one or more sensors are configured to detect one or more properties of the magnetic field and to detect one or more changes in the properties of the magnetic field as the coiled tubing approaches, moves through and moves away from the central passageway.

Some embodiments of the present disclosure relate to a method for detecting a damaged section of coiled tubing within a pressurized section of a well. The method comprises the steps of: generating a magnetic field within the pressurized section of the well; exposing the coiled tubing to the magnetic field while moving the coiled tubing through the pressurized section of the well; and detecting any changes in the magnetic field as the coiled tubing approaches, moves through and moves away from the magnetic field. In some embodiments of the present disclosure, the changes in the magnetic field are substantially caused by the damaged section of the coiled tubing.

Some embodiments of the present disclosure relate to positioning the inspection device within the pressurized section of the well. This positioning may avoid catastrophic events because a damaged section of the coiled tubing can be detected by the inspection device at a location, within the pressurized section of the well, where there is a substantially small or no pressure differential and/or less of a bending force acting upon the damaged section. If a damaged section of the coiled tubing is detected within the pressurized section, then the fluid pressure inside of the coiled tubing can be relieved, for example by bleeding-off fluids and relieving the pressure, so that when the damaged section is removed from the pressurized section the damaged section will not be subjected to a pressure differential. Subjecting the damaged section to a pressure differential outside of the pressurized zone of the well may result in the coiled tubing rupturing outside of any pressure containment mechanisms of the well, which is a serious safety concern. Also, the coiled tubing can become further damaged and even break which may cause a portion of the coiled tubing, and any tools attached thereto, to fall down into the well.

### BRIEF DESCRIPTION OF THE DRAWINGS

These and other features of the present disclosure will become more apparent in the following detailed description in which reference is made to the appended drawings.

FIG. 1 is a side-elevation view of a schematic that shows a coiled-tubing system with one embodiment of an inspection apparatus for use in an oil-and-gas well;

FIG. 2 is an isometric view of one embodiment of an inspection tool for use with the coiled-tubing system of FIG. 1;

FIG. 3 shows other views of an embodiment of an inspection tool: FIG. 3A shows a top plan view of one embodiment of an inspection tool without a body; FIG. 3B is a view taken along line B-B in FIG. 3A with the body included;

FIG. 4 is a side-elevation view of a schematic that shows coiled tubing passing through two embodiments of the inspection tool and visual outputs of detected changes in the magnetic field that are detected by the inspection tools over time: FIG. 4A shows a section of coiled tubing with a damaged section that is approaching one embodiment of the inspection tool; FIG. 4B shows an example of a visual output of the detected changes in the magnetic field over time as a damaged section approaches, moves through and moves beyond the inspection tool shown in FIG. 4A; FIG. 4C shows a section of coiled tubing with a damaged section that has a different orientation than as shown in FIG. 4A and that is approaching the inspection tool of FIG. 4A; FIG. 4D shows an example of a visual output of the detected changes in the magnetic field over time as the damaged section approaches, moves through and moves beyond the inspection tool shown in FIG. 4C; FIG. 4E shows a section of coiled tubing that contains a damaged section with a similar orientation than as shown in FIG. 4C that is approaching another embodiment of the inspection tool; FIG. 4F shows an example of a visual output of the detected changes in the magnetic field over time as the damaged section approaches, moves through and moves beyond the inspection tool shown in FIG. 4E;

FIG. 5 is a side-elevation view of a schematic that shows coiled tubing passing through two embodiments of the inspection tool and visual outputs of detected changes in the magnetic field detected by the inspection tools over time: FIG. 5A shows a section of coiled tubing with a damaged section that is approaching one embodiment of the inspection tool; FIG. 5B shows an example of a visual output of the detected changes in the magnetic field over time as the damaged section approaches, moves through and moves beyond the inspection tool shown in FIG. 5A; FIG. 5C shows a section of coiled tubing with a damaged section that has a similar orientation than as shown in FIG. 5A that is approaching the inspection tool of FIG. 5A; FIG. 5D shows an example of a visual output of the detected changes in the magnetic field over time as the damaged section approaches, moves through and moves beyond the inspection tool shown in FIG. 5C; FIG. 5E shows a section of coiled tubing that contains a damaged section with a similar orientation than as shown in FIG. 5C that is approaching another embodiment of the inspection tool; FIG. 5F shows an example of a visual output of the detected changes in the magnetic field over time as the damaged section approaches, moves through and moves beyond the inspection tool shown in FIG. 5E;

FIG. 6 shows another embodiment of an inspection tool for use with the coiled-tubing system of FIG. 1;

FIG. 7 shows another embodiment of an inspection tool for use with the coiled-tubing system of FIG. 1; and

FIG. 8 shows one embodiment of different steps of a method for inspecting coiled tubing.

### DETAILED DESCRIPTION

Unless defined otherwise, all technical and scientific terms used herein have the same meaning as commonly understood by one of ordinary skill in the art to which this disclosure belongs.

As used herein, the term “about” refers to an approximately +/−10% variation from a given value. It is to be understood that such a variation is always included in any given value provided herein, whether or not it is specifically referred to.

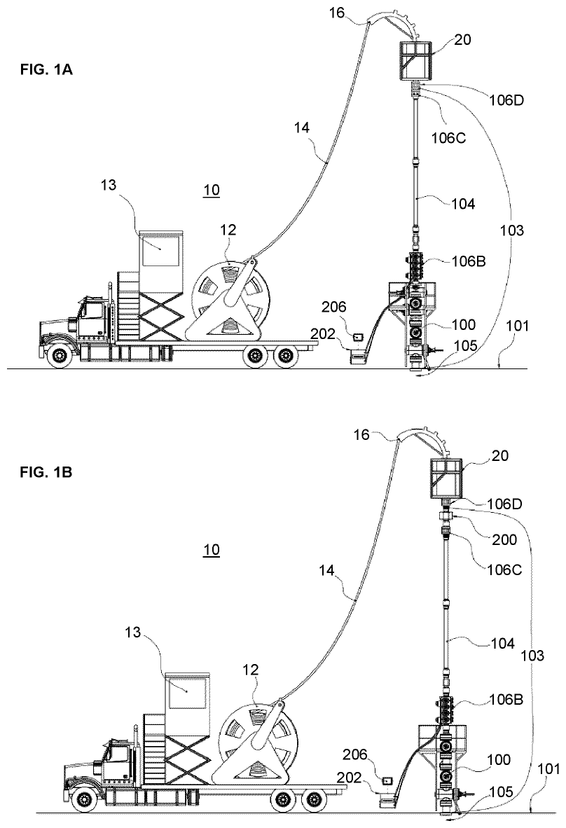

FIG. 1 shows a schematic of a coiled-tubing system 10 that is used in an oil and/or gas well 100. The coiled-tubing system 10 comprises a coiled-tubing reel 12 that is controlled by equipment within a coiled-tubing control cab 13. The coiled tubing 14 that is wound around the reel 12 can extend towards a guide arch 16, which is also known as a gooseneck, and into a coiled-tubing injector head 20. The coiled-tubing injector head 20 may guide the coiled tubing 14 as it is inserted into the well 100 and withdrawn from of the well 100. The coiled tubing 14 can be used to introduce fluids into the well 100 and it may also be used to actuate one or more downhole tools. The coiled tubing 14 may have a substantially constant cross-sectional diameter.

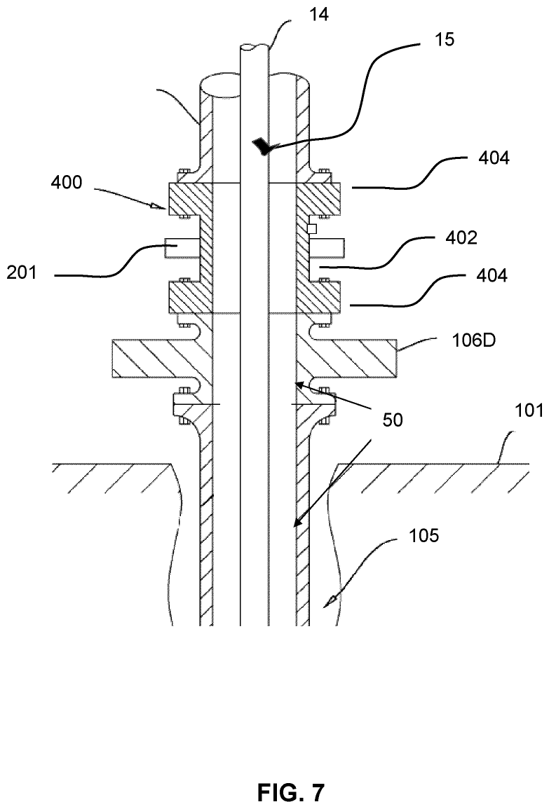

FIG. 1 shows an above-surface portion 102 of the well 100 that is above a surface 101 into which the well 100 extends. The portion of the well 100 that is below the surface 101, and not specifically shown in FIG. 1, is referred to herein as a downhole portion 105. The above-surface portion 102 of the well 100 comprises a coiled-tubing riser 104. Generally, the riser 104 is in fluid communication with the downhole portion 105 of the well 100 via a central bore 50 of the well 100 (shown in FIG. 7). Accordingly, the fluid pressure within the riser 104 is generally similar to the downhole portion 105. As such the components of the above-surface portion 102 that are exposed to generally similar fluid pressure as the downhole portion 105 may be housed within a pressure-containment section 103. For clarity, when pressurized fluid is being conducted through the coiled tubing 14 the fluid pressure difference across the outer surface of the coiled tubing 14 within the pressure-containment section 103 may be smaller than when the coiled tubing 14 is outside of the pressure-containment section 103.

In order to control the pressure within the pressure-containment section 103 there may be one or more pressure control mechanisms 106, such as one or more preventers, blow out preventers (BOP), bleed lines, pack-offs or strippers. FIG. 1 shows non-limiting examples of the pressure control mechanisms 106 as including a primary BOP, and a coiled-tubing pack-off stripper 106C. The injector head 20 may be positioned above one or more pack-off strippers 106C and 106D. The injector head 20 is not within the pressure-containment section 103.

Embodiments of the present disclosure include an inspection tool 200 that is positioned under the injector head 20 and a first pack off stripper 106C and above a second pack-off stripper 106C2 This positioning of the inspection tool 200 places it within the pressure-containment section 103. Without being bound by any particular theory, positioning the inspection tool 200 at any point within the pressure-containment section 103 may allow the inspection tool 200 to detect a damaged portion 15 of the coiled tubing 14. Furthermore, because the inspection tool 200 is located within the pressure-containment section 103, this can be at a location where the pressure differential between the inside and the outside of the coiled tubing 200 is substantially less than the pressure differential between the inside and the outside of the coiled tubing 14 when the coiled tubing 14 is outside of the pressure-containment section 103. For example, when the coiled tubing 14 is outside of and above the pressure-containment section 103, atmospheric pressure may be exerted on the outside of the coiled tubing 14 and atmospheric pressure may be lower than pressurized fluids within the coiled tubing 14. Detecting a damaged portion 15 when it is positioned within the pressure-containment section 103 may allow an operator to safely bleed off the fluid within the coiled tubing 14 and to equalize the fluid pressure within the coiled tubing 14 with atmospheric pressure before the coiled tubing 14 exits the pressure-containment section 103. This bleed-off may avoid exposing a damaged section 15 of the coiled tubing 14 to a pressure differential between the inside and the outside of the coiled tubing 14 that can cause a catastrophic rupture of the coiled tubing 14 at the above-surface portion 102 of the well 100. The damaged section 15 is a portion of the coiled tubing 14 where the integrity of the metal wall is structurally compromised. The damaged section 15 may also be referred to herein as a defect.

The inspection tool 200 can generate a magnetic field that extends at least partially across a central passageway 234, as described herein below. The magnetic field is influenced by the metal wall of the coiled tubing 14 as it approaches, moves through and moves away from the inspection tool 200. As one skilled in the art will appreciate, the movement of the coiled tubing 14 through the inspection tool 200 can when the coiled tubing 14 is being inserted into the well 100 and when it is being removed from the well 100. The inspection tool 200 can detect changes in the magnetic flux density and/or the strength of the generated magnetic field that are caused by the coiled tubing 14 influencing the properties of the magnetic field. These detected changes are used to determine the integrity of the metal wall of the coiled tubing 14. The inspection tool 200 is electronically connectible to a processor unit 202, which may also be referred to as a controller, by a data transfer and power cord 204 or wirelessly, which may also be referred to herein as a wire. The processor unit 202 may also be electronically connectible to a display 206. Optionally, the display 206 is positionable within the control cab 13 so that an operator can see a visual output of the processor unit 202.

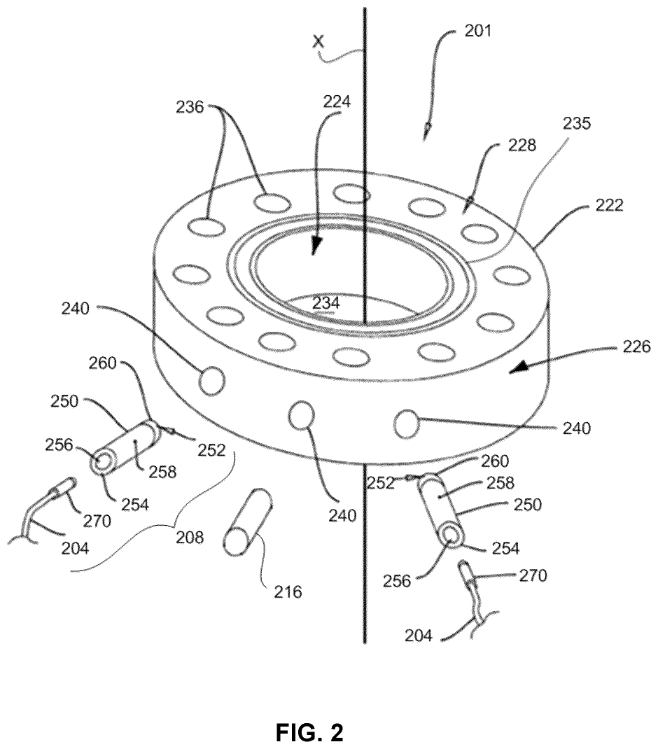

FIG. 2 shows one embodiment of the inspection tool 200 that includes a first sensor array 201 that includes one or more sensor units 208 and one or more magnets 216. Some embodiments of the inspection tool 200 include multiple sensor arrays 201. Within the first sensor-array 201 shown in FIG. 2 the sensor units 208 and the magnets 216 are arranged in an alternating pattern, but this alternating pattern is not required. The sensors described in U.S. Pat. No. 9,097,813, the entire disclosure of which is incorporated herein by reference, may be suitable for use in some embodiments of the present disclosure as a first sensor array 201.

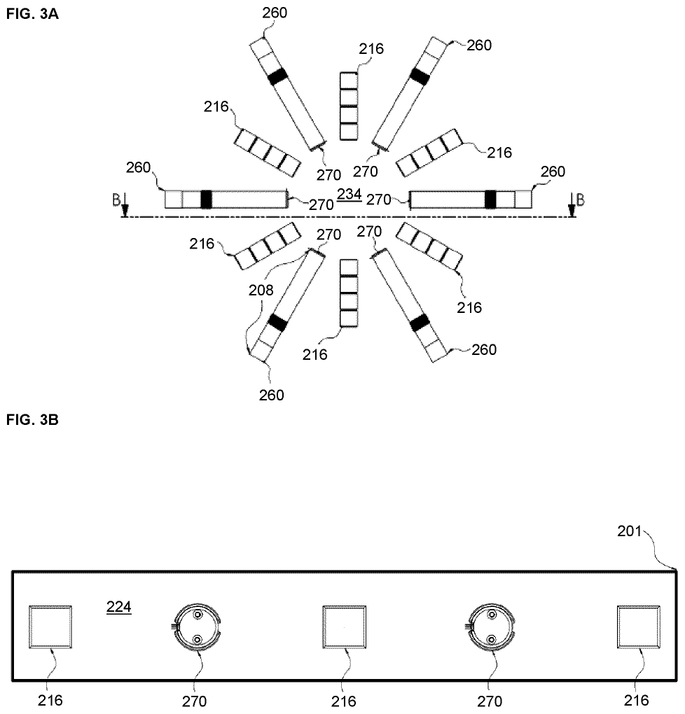

For example, FIG. 2 shows one embodiment of the first sensor-array 201 according to the present disclosure. The array 201 comprises a body 222 having a plurality of sensor bores 240 therein each adapted to receive an individual sensor unit 208 therein. The body 222 may be an annular or ring-shaped spool having inner surface 224 and an outer surface 226 that extend between a top surface 228 and a bottom surface 230. The inner surface 224 defines a central passage 234. The inner and outer surfaces 224, 226 are substantially cylindrical about a central axis, shown as line X in FIG. 2. In some embodiments of the present disclosure, the sensor unit 208 comprises a sleeve 250 and a sensor 270. In some embodiments of the present disclosure, the sensor unit 208 comprises the sleeve 250, the sensor 270 and a further magnet 260. While the further magnet 260 is shown in FIG. 3A as being proximal the central passage 234, the further magnet 260 may also be proximal to the sensor 270 and distal from the central passage 234. When the inspection tool 200 is integrated into the well 100, the central axis X is co-axial with a central axis of the other components of the above-surface portion 102 of the well 100. The central passage 234 extending through the inspection tool 200 may be sized and shaped to receive the coiled tubing 14, which can be of various dimensions and sizes. In some embodiments of the present disclosure, the top surface 228 and the bottom surface 230 may be substantially planar along a plane normal to the central axis X. Optionally either or both of the top surface 228 and the bottom surface 230 may include a seal groove 235 extending annularly therearound for receiving a seal, as are known in the art.

In some embodiments of the present disclosure, the body 222 includes a plurality of bolt holes 236 that extend through the top surface 228 and the bottom surface 230 along an axis that may be substantially parallel to the central axis X. The bolt holes 236 may receive fasteners (not shown), such as bolts therethrough to secure the body 222 inline and in fluid communication with the other components of the above-surface portion 102 of the well 100, according to methods known to those skilled in the art.

The sensor bores 240 extend from the outer surface 226 towards the inner surface 224. In some embodiments of the present disclosure, the sensor bores 240 are blind bores extending to a predetermined depth within the body 222 that is a distance less than the distance from the outer surface 226 to the inner surface 224. In such a manner, the sensor bore 240 will maintain a barrier wall between the sensor bore 240 and the central passage 234 so as to maintain a fluid tight seal. The barrier wall may have a thickness selected to provide adequate burst strength of the sensor unit 208. In other embodiments of the present disclosure, the sensor bore 240 extends completely through the body 222 to fluidly communicate between the inner surface 224 and the outer surface 226. The sensor bores 240 may be arranged about the central passage 234 along a common plane normal to the axis X of the central passage 234 although it is appreciated by one skilled in the art that other orientations may be useful as well.

The body 222 may have any height between the top and bottom surfaces 228 and 230 as is necessary to accommodate the sensor bores 240. In some embodiments of the present disclosure, the body 222 has a height between about 3.5 inches and about 24 inches (about 89 mm and about 610 mm). The body 222 may have an inner diameter (ID) of the inner surface 24 that allows the passage of the coiled tubing 14 and an outer surface 226 OD that provides a sufficient depth for the sensor bores 240.

The body 222 may be formed of a non-magnetic material, such as, by way of non-limiting example a nickel-chromium alloy. One example of a non-magnetic material is INCONEL® (INCONEL is a registered trademark of Vale Canada Limited). It will also be appreciated by one skilled in the art that other non-magnetic materials may also be useful such as but not limited to duplex stainless steel, super duplex stainless steel provided these materials do not interfere with the sensor's 270 operation as described below.

The sensor bores 240 are each configured to receive the sleeve 250. The sleeve 250 comprises a tubular member that extends between a first end 252 and a second end 254 and having an inner surface 256 and an outer surface 258. As illustrated in FIG. 2, the outer surface 258 of the sleeve 250 may be selected to correspond closely to the dimensions of the sensor bores 240 in the body 222. The sleeves 250 are formed of a substantially ferromagnetic material, such as steel so as to conduct or propagate the magnetic field towards a sensor 270 that can be associated with each sensor bore 240. The sleeves 250 are selected to have a sufficient OD to be received within the sensor bores 240 and an inner surface diameter sufficient to accommodate the sensor 270 therein. The sleeve 250 may also have a length that is sufficient to receive the sensor 270 therein. The OD of the sleeve 250 may also optionally be selected to permit the sleeve 250 to be secured within one sensor bore 240 by an interference fit or with the use of adhesives, fasteners, plugs or the like.

The sleeves 250 may also each include one or more magnets 216 that are positionable at the first end 52 thereof. The magnets 216 are selected to generate strong magnetic fields. In some embodiments of the present disclosure, the magnets 216 are oriented with the same magnetic pole facing the center of the inspection tool 200 to create a magnetic field that corresponds to the common centrally facing magnetic pole of the magnets 216. The magnetic field may be strongest on or near the internal wall 224 of the inspection tool 200 and the use of multiple magnets 216 may create a substantially homogeneous and evenly distributed magnetic field within or about the inspection tool 200. In particular, it has been found that rare earth magnets, such as but not limited to: neodymium, samarium-cobalt are useful. Electromagnets are also useful. The magnets 216 may be nickel plated, or not. The magnets 216 are located at the first ends 252 of the sleeves 250 and they are retained in place by the magnetic strength of the magnets 216. Optionally, the sleeve 250 may include an air gap (not shown) between the magnet 216 and the barrier wall 242 of up to about 0.5 of an inch (about 13 mm) although other distances may be useful as well.

An individual sensor 270 is insertable into the open second end 254 of each sleeve 250 and is retained within the sleeves 250 by any suitable means, such as but not limited to: an adhesive, threading, a fastener or the like. In some embodiments of the present disclosure the sleeve 250 can be a solid article with an individual sensor 270 attached at one end thereof. The sensors 270 are selected to provide an output signal in response to the magnetic field in their proximity. For example, the sensors 270 may comprise magnetic sensors, such as a Hall Effect sensor although it will be appreciated that other sensor types may be utilized as well. In some embodiments of the present disclosure a Hall Effect sensor, such as a model SS496A1 sensor manufactured by Honeywell is useful. It will be appreciated that other sensors are also suitable. The sensor 270 may be located substantially at a midpoint within each sleeve 250 although other locations within the sleeve 250 may be useful as well. The sensors 270 may be oriented to focus towards the center of the inspection tool 200.

The sensor 270 is configured to provide an output signal to the processor unit 202. The sensor 70 may be wired via cord 204 or the sensor 270 may be wirelessly or otherwise connected to the processor unit 202. The sensor 270 is configured so that the output signal represents a change that is detected in the magnetic field that passes through the metal wall of the coiled tubing 14 passing through the inspection tool 200.

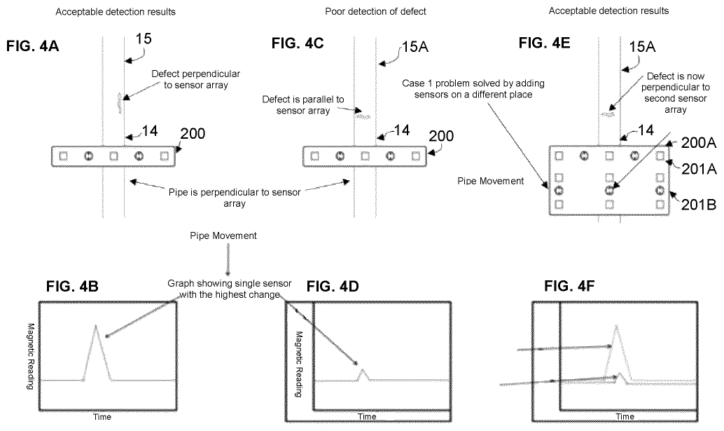

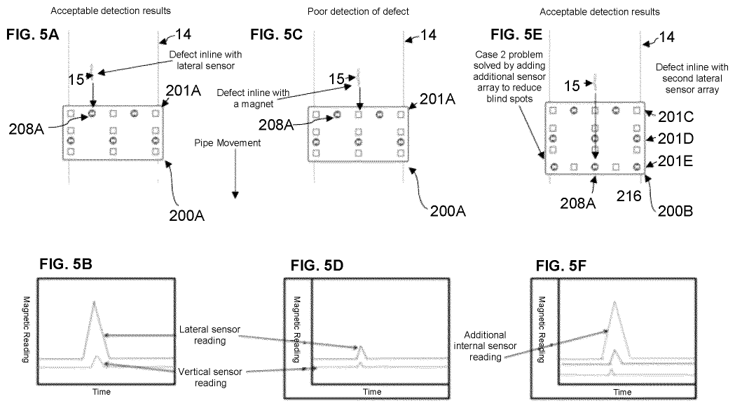

The processor unit 202 may be any one of the commonly available personal computers or workstations having a processor, a microprocessor, a field programmable gate array, programmable logic controller or combinations thereof that include a volatile and non-volatile memory, and an interface circuit for interconnection to one or more peripheral devices for data input and output. In some embodiments of the present disclosure, the processor unit 202 may include processor-executable instructions, in the form of application software, may be loaded into the memory of the controller 202 that allow the processor unit 202 to adapt its processor to receive, store and query various input signals. In some embodiments of the present disclosure, the processor unit 202 can also send one or more instructions or commands to other components of the inspection tool 200. For example, the processor unit 202 can send a display signal to a display 206 that visually displays the signal output by one or more sensor arrays 201 over time (for example see FIG. 3B, FIG. 3D, FIG. 3F, FIG. 4B, FIG. 4D, FIG. 4F and FIG. 5). The signal output represents the detected parameters of the magnetic field and changes thereto.

When a ferromagnetic object, such as coiled tubing 14, approaches, moves through or moves away from the inspection tool 200, the ferromagnetic object draws at least a portion of the magnetic field on to or about its surface, which may change the distribution of the magnetic field within in the inspection tool 200. This changed distribution will be reflected in changes in the measurements of the one or more properties of the magnetic field made by the sensors 270. When the coiled tubing 14 is moving into or out of the well 100, the coiled tubing 14 is substantially centralized, as described further herein below. Also, the cross-sectional diameter of the coiled tubing 14 is substantially constant and, therefore, the distance between the inner surface of the inspection tool 200 and each of the sensors 270 and the outer surface of the coiled tubing 14 is substantially equal. This means that the one or more properties of the magnetic field detected by the inspection tool 200 remains substantially constant as the coiled tubing 14 is moving through the well 100 until a damaged section 15 approaches, moves towards or moves away from the inspection tool 200. The damaged section 15 will change how the magnetic field is distributed across that damaged portion of the coiled tubing 14 and this change will be different from the otherwise substantially constant measurements of the one or more properties detected by the sensors 270 when undamaged sections of the coiled tubing 14 are approaching, moving through or moving away from the inspection tool 200. In other words, any detected changes in the measurements of the one or more properties of the magnetic field may indicate a perturbation in the magnetic field caused by the damaged section 15.

In some embodiments of the present disclosure, the coiled tubing 14 may be substantially centralized and mechanically restrained from lateral movement within the pressure-containment section 103 and optionally between the one or more pack-off strippers 106C and 106D. In some embodiments this mechanical restraint may substantially centralize the coiled tubing 14 within the inspection tool 200 and/or the magnetic field. The mechanical restraint may also reduce or substantially prevent lateral movement of the coiled tubing 14 when the coiled tubing 14 is proximal to the inspection tool 200, whether moving or not. The mechanical restraint of the coiled tubing 14 may arise by one or more of the one or more pack-off strippers 106C, 106D, the central passage 234 of the inspection tool 200 itself or some other type of wellhead centralizer member may be used. For example, the central passage 234 may be configured to substantially centralize the movement of the coiled tubing 14 proximal to the inspection tool 200. Because the coiled tubing 14 is mechanically restrained and because it has a substantially constant diameter, the changes in the properties of the magnetic-field that are detected by the inspection tool 200 may indicate that a damaged section 15 is approaching, moving through or moving away from the inspection tool 200. For example, when the processor unit 202 receives the output signal from the inspection tool 200, and the output signal indicates that there is a change in a detected property of the magnetic field, the processor unit 202 will convert the output signal to generate a visual output signal that indicates a damaged section 15 is approaching, moving through or moving away to the inspection tool 200. Because the inspection tool 200 is positioned within the pressure-containment section 103, the movement of the coiled tubing 14 can be stopped, the pressurized fluids within the coiled tubing 14 can be bled off and the coiled tubing 14 can then be moved up and out of the injector head 20 for further inspection while substantially lowering the risk of a dangerous pressure-loss event at the well 100.

The measurements of the one or more properties of the magnetic field captured by the sensors 270 depends on the strength or number of the magnets 216 positioned within the inspection tool 200. However, changes in the magnetic-field strength within the inspection tool 200 can be due to a ferromagnetic object and the magnitude of those changes can depend on the dimensions and/or materials of the ferromagnetic object and/or the integrity of the ferromagnetic object (i.e. the presence or absence of any damaged sections in the metal wall of the coiled tubing).

FIG. 3A shows a top plan view of the inspection tool 200 with the body 222 removed. FIG. 3B shows a side elevation view of the inspection tool 200 with the first sensor array 201 arranged in substantially the same plane, which may also be referred to herein a lateral arrangement. In other embodiments of the present disclosure, the first sensor array 201 is arranged in a vertical arrangement where a magnet 216 is positioned above and another magnet 216 is positioned below the sensor unit 208. In this vertical arrangement, the first sensor array 201 may comprise multiple groups of a sensor unit 208 vertically positioned between two magnets 216 that are positioned about the inner surface 224 of the inspection tool 200. In other embodiments of the present disclosure, the inspection tool 200 may include multiple sensor arrays 201 with either or both of the lateral arrangement and the vertical arrangement or arrangements of sensor arrays 201 that are between the lateral and vertical arrangement. For example, the one or more sensor arrays 201 may be arranged at any degree between about 0 and about 90 degrees relative to vertical. In some embodiments of the present disclosure the one or more sensor arrays 201 may be arranged between about 30 and about 60 degrees relative to the vertical. In some embodiments of the present disclosure the one or more sensor arrays 201 may be arranged at about 45 degrees relative to the vertical.

Further to the lateral and vertical sensor arrays, additional sensor arrays may be positioned with an arrangement between lateral and vertical. For example, 45 degrees from vertical has proved advantageous. FIG. 4A shows a section of coiled tubing 14 that is moving through the inspection tool 200 with the first sensor array 201 arranged in the lateral arrangement. For clarity, the inspection tool 200 is shown in FIGS. 4A, 4C and 4E with the same view as shown in FIG. 3B so that the arrangement of the first sensor array 201 can be seen. As in FIG. 3B, the circular shapes depicted within the inspection tool 200 of FIG. 4 each represent one of the sensors 208 and the square shapes each represent one of the magnets 216. In FIG. 4A the section of coiled tubing 14 is moving downward into the well 100. The coiled tubing 14 includes a damaged section 15 that is oriented generally co-axial with the coiled tubing 14. The damaged section 15 is substantially perpendicular to the lateral arrangement of the first sensor array 201 and the damaged section 15 is substantially aligned to pass through a middle sensor 208A of the inspection tool 200. FIG. 4B is a schematic diagram that shows a visual output that the processor unit 202 generates and communicates to the display 206 based upon changes in the magnetic field that are detected as the coiled tubing 14 and the damaged section 15 passes through the inspection tool 200.

The visual output is at least partially based upon the orientation of the damaged section 15 relative to the magnetic field generated by the inspection unit 200. The X axis of the visual display represents time and the Y axis represents the amplitude of the change in the magnetic field, for example changes in magnetic flux, as the damaged section 15 approaches, moves through and moves away from the inspection tool 200. The visual outputs shown in FIG. 4 and FIG. 5 are based upon the coiled tubing 14 moving at substantially the same rate.

FIG. 4C shows another section of coiled tubing 14 that is moving towards an inspection tool 200 with the first sensor array 201 arranged in the lateral arrangement. In FIG. 4A this section of coiled tubing 14 is moving downward into the well 100. The section of coiled tubing 14 includes a damaged section 15A that is oriented generally perpendicular to the longitudinal axis of the coiled tubing 14. The damaged section 15A is substantially parallel to the lateral arrangement of the first sensor array 201 and the damaged section 15 is also aligned to pass through the middle sensor 208 of the inspection tool 200. As shown in FIG. 4D, the amplitude of the change in the magnetic field signal is smaller than that shown in FIG. 4B. Without being bound by any particular theory, this result is due to the orientation and alignment of the damaged section 15 as compared to the damaged section 15A and how much time these damaged sections 15, 15A are in proximity to the sensors 208 of the sensor array 201.

In some embodiments of the present disclosure the inspection tool 200 may have two or more sensor arrays 201. For example, FIG. 4E shows an inspection tool 200A with a first sensor array 201A and a second sensor array 201B. While FIG. 4E shows the first sensory array 201A as having a lateral arrangement and the second sensor array 201B as having a vertical arrangement, the two sensor arrays 201A, 201B may have different arrangements, or not, and the first sensor array 201A may have a vertical arrangement. The two sensor arrays 201A, 201B are spaced apart along the central axis of the inspection tool 200 so that the first array 201A is positioned above the second array 201B when the inspection tool 200 is positioned within the pressure-containment section 103 of the well 100. FIG. 4F shows the visual output that is generated when there are two sensor arrays 201A, 201B that have different arrangements. The amplitude of the visual out of the detected change in the magnetic field that is caused by the damaged section 15 is larger and more readily apparent in FIG. 4F as compared to FIG. 4D

FIG. 5A and FIG. 5C show another section of the coiled tubing 14 with a damaged section 15 approaching the inspection tool 200A. In FIG. 5A the damaged section 15 is substantially aligned with the middle sensor 208A of the first sensor array 201A and in FIG. 5C the damaged section 15 is not substantially aligned with any sensor 208 of the first or second sensor arrays 201A, 201B. FIG. 5D shows a smaller amplitude of the visual output of the detected change in the magnetic field that is caused by the damaged section 15A as compared to FIG. 5B.

FIG. 5E shows another section of the coiled tubing 14 with a damaged section 15 approaching an inspection tool 200B that has three sensor arrays 201C, 201D and 201E, respectively. The first sensor array 201C and the third sensor array 201E are shown as having a lateral arrangement and the second sensor array 201D is shown as having a vertical arrangement. The three sensor arrays 201A, 201B and 201C are spaced apart along the central axis of the inspection tool 200 so that the first array 201A is positioned above the second array 201B, which is positioned above the third array 201C when the inspection tool 200 is positioned within the pressure-containment section 103 of the well 100. FIG. 5E also shows that the middle sensor 208A of the first sensor array 201C is substantially aligned with a magnet 216 of the third sensor array 201E. This relative alignment of the sensors 208 of one sensor array 201 as compared to the magnets 216 of another sensor array 201 may be referred to herein as being an offset arrangement. It will be appreciated by one of skill in the art that the arrangement and number of the sensor arrays 201 can be different among different embodiments of the present disclosure and the offset arrangement is not required. FIG. 5F shows the amplitude of the visual output of the change in the magnetic field that is detected by the three sensor arrays 201C, 201D and 201E as the damaged section 15A approaches, passes through and moves away from the inspection tool 200B. The amplitude of the visual output in FIG. 5F is more readily detected than the visual output shown in FIG. 5D.

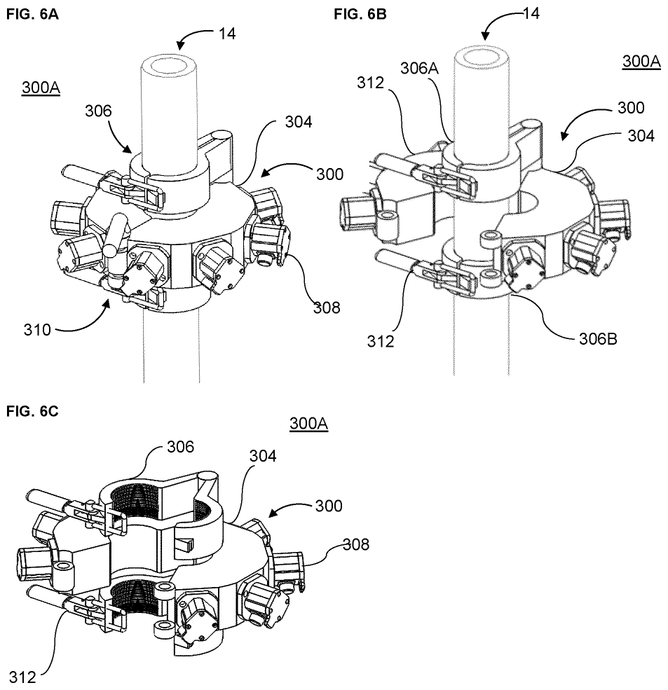

FIG. 6 shows another embodiment of an inspection tool 300A that can be used in the coiled-tubing system shown in FIG. 1. The inspection tool 300A can be configured to receive the coiled tubing 14 therethrough. The inspection tool 300A can move between a closed position (as shown in FIG. 6A), a partially-open position (as shown in FIG. 6B) and a fully-opened position (as shown in FIG. 6C).

In some embodiments of the present disclosure the inspection tool 300A may comprise a body 300 and an optional second body 306. The first body 304 comprises one or more magnetic field generators, such as the magnets 216 described above, and one or more magnetic sensors, such as the sensors 270 described above, that can be housed within bores (not shown) of the first body 304. Each bore may be covered with a bore cap 308. The bore caps 308 can ensure that the magnetic field generators and the magnetic sensors are retained within their respective bores. The magnetic field generators can be magnets 216 that create a magnetic field proximal the first body 304. The sensors 270 can detect changes in the magnetic field and/or the magnetic flux proximal the first body 300. As described above, the sensors 270 are configured to provide an output signal to the processor unit 202. The sensor 270 is configured so that the output signal represents a change that is detected in the magnetic field that is caused by the coiled tubing 14 and any damaged sections 15, 15A passing through the inspection tool 300A.

The first body 304 can include an actuating member (not shown) that allows the first body 304 to move between a closed position (as shown in FIG. 6A) and an open position (as shown in FIG. 6B and FIG. 6C). For example, the actuating member may be a hinge and the body 304 may be a clam-shell type of arrangement. The first body 304 may also include one or more connectors 310 that can hold the first body 304 in the closed position. While FIG. 6A shows the connector 310 as a pin and slot arrangement, other types of connectors 310 are contemplated.

The second body 306 may comprise an upper second body 306A that is positioned above the first body 304 and a lower second body 306B that is positioned below the first body 304. The upper bodies 306A, 306B can also move between a closed position (as shown in FIG. 6A and FIG. 6B) and an open position (as shown in FIG. 6C). When the first body 304 and the second body 306 are both open, the body 300 is in the fully-opened position. The second bodies 306A, 306B may also include actuating members and connectors 312 that allow the second bodies 306A, 306B to move between the open and closed positions and to hold the second bodies 306A, 306B in the closed position, respectively.

In some embodiments of the present disclosure the magnetic field generators may be electromagnets and when the first body 304 of the body 300 is in the closed position, the magnetic field generators may be activated and the magnetic field is generated. When the first body 304 is in the open position the magnetic field generators may be off.

In some embodiments of the present disclosure, the body 300 may comprise one or more sections that can be connected together to form a complete body 300 that is held together by multiple connectors 312. In these embodiments the body 300 does not include an actuating member.

In some embodiments of the present disclosure the inspection tool 300A may include multiple magnets 216 and multiple sensors 270 that are arranged in one or more arrays 201, as described herein above. There may be single or multiple vertical, lateral or sensor arrays 201 that are arranged at any angle relative to the vertical.

FIG. 7 shows another example of an inspection tool 400 that has many of the same components as the inspection tool 200, 300A described herein above. Components that are the same between the different inspection devices 200, 300A, 400 are referred to in FIG. 7 using the same reference numbers as used in the other figures herein. The inspection tool 400 shown in FIG. 7 is similar to the apparatus described in the applicant's prior patent application WO 2017/205955 entitled APPARATUS AND METHOD FOR MEASURING A PIPE WITHIN AN OIL WELL STRUCTURE, the entire disclosure of which is incorporated herein by reference. Briefly, the inspection tool 400 comprises a tubular body 402 that defines a central passage between first and second ends. The tubular body 402 has at least an outer surface that is formed of a non-magnetic material. In some embodiments of the present disclosure, some or all of the tubular body 402 is formed of a non-magnetic material. Each of the first and second ends has a flange 404 that extends outwardly therefrom, substantially perpendicular to the central passage. The flanges are connectible with other components of the well 100 so that the central passage is substantially aligned with the central bore 50 of the well 100. The inspection tool 400 may include multiple magnets 216 and multiple sensors 270 that are arranged in one or more arrays 201, as described herein above. There may be single or multiple vertical arrays 201, lateral arrays 201 or sensor arrays 201 that are arranged at any angle relative to the central passageway. The arrays 201 may be positionable around the tubular body 402 upon the outer surface. The arrays 201 may operate in the same manner as described herein above to detect as a damaged section 15 of coiled tubing approaches, moves through or moves away from the inspection tool 400.

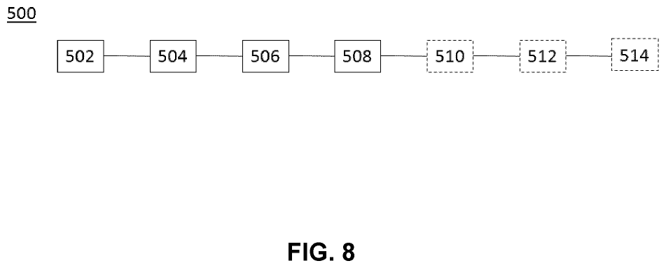

The present disclosure also relates to a method 500 of inspecting coiled tubing 14 as the coiled tubing is being run into or out of the well 100 (as shown in FIG. 8, with some optional steps shown in dashed-line boxes). This method comprises at least a step of running 502 coiled tubing 14 so that it is received through an inspection tool 200, 200A, 200B or 300A. Generating 504 a magnetic field with the inspection tool 200, 200A, 200B or 300A and exposing the magnetic field to the coiled tubing 14 so that the magnetic field is attracted towards and distributed across the ferromagnetic walls of the coiled tubing 14. Detecting and/or measuring 506 one or more parameters of the magnetic field, using the inspection tool 200, 200A or 200B, as the coiled tubing 14. Identifying 508 that a damaged section 15, 15A is approaching, moving through or moving away from the magnetic field by detecting a change in one or more properties of the magnetic field. The method may include an optional step of positioning 510 the inspection tool 200, 200A, 200B and 300A within the pressure-containment section 103 of the well 100. The method further includes a step of measuring the detected magnetic-field changes and assessing whether the coiled tubing 14 has a damaged section 15, 15A.

In some embodiments of the present disclosure, the method may further comprise an optional step of filtering 512 by comparing the measurements of the one or more properties of the magnetic field, and any changes thereto, to known magnetic measurement curves that were obtained under known conditions of temperature, known dimensions and materials of ferromagnetic objects. For example, the step of filtering 512 may assist in correcting for changes in temperature proximal the inspection tool 200 and for identifying magnetic anomalies in the coiled tubing 14 that may each create a false signal that a damaged section 15 is approaching, moving towards or moving away from the inspection tool 200. Additionally, the method may include an optional step of measuring 514 one or more properties of the well 100 itself. The measured one or more properties of the well 100 are any properties that can influence a magnetic field and may include but are not limited to: the geometry and material properties of the well 100 and any influence of other equipment that is operating proximal to the well 100. Then these measurements may be applied as a magnetic offset calculation within the conversion performed by the processor unit 202 to correct for differences (in geometry, materials and nearby equipment) between different wells 100 in which the inspection tool 200, 300A, 400 may be used.

If the assessing step indicates that there is a damaged section 15, 15A, then the fluid inside of the coiled tubing 14 can be bled off so that when the coiled tubing 14 moves out of the pressure-containment section 103, there is a substantially equal pressure acting on the inside and the outside of the coiled tubing 14. The damaged section 15 can then safely be removed from the pressure-containment section 103 for further inspection, maintenance or removal.

While the embodiments of the present disclosure are described in reference to inspecting coiled tubing 14 as it moves through a well 100, it is understood by those skilled in the art that these embodiments may also be used to inspect coiled tubing 14 before or after it is inserted into a well 100.

1. A coiled-tubing system for inserting and withdrawing coiled tubing into a well that has a pressure-containment section, the system comprising:
(a) a length of coiled tubing that is windable about a coiled tubing reel;
(b) a coiled tubing injector head that is connectible to the well above the pressure-containment section; and
(c) an inspection tool that is connected to the well within the pressure-containment section, the inspection tool is configured to generate a magnetic field and to detect one or more properties of the magnetic field as a section of coiled tubing approaches, passes through and moves away from the inspection tool.

2. The coiled-tubing system of claim 1, wherein the inspection tool is further configured to detect a change in the one or more properties of the magnetic field as a damaged section of the coiled tubing approaches, moves through and moves away from the inspection tool.

3. The coiled-tubing system of claim 1, wherein the inspection tool further comprises one or more magnets are configured to generate the magnetic field.

4. The coiled-tubing system of claim 2, wherein the inspection tool further comprises one or more sensors that are configured to detect one or more properties of the magnetic field.

5. The coiled-tubing system of claim 4, wherein the one or more sensors are further configured to detect changes in the detected one or more properties of the magnetic field.

6. The coiled-tubing system of claim 4, wherein the one or more sensors and the one or more magnets are arranged in a first sensor array.

7. The coiled-tubing system of claim 4, wherein the one or more sensors and the one or more magnets are arranged in a first sensor array and a second sensor array and wherein the first sensor array and the second sensor array are spaced apart along a central passageway of the inspection tool.

8. The coiled-tubing system of claim 4, wherein the one or more sensors and one or more magnets are arranged in a first sensor array, a second sensor array and a third sensor array.

9. The coiled-tubing system of claim 8, wherein the first sensor array is in a lateral arrangement or a vertical arrangement.

10. The coiled-tubing system of claim 9, wherein the second sensor array is in a lateral arrangement or a vertical arrangement.

11. The coiled-tubing system of claim 7, wherein the first sensor array and the second sensor array are in an offset arrangement.

12. A coiled-tubing inspection tool comprising:
(a) a body that defines a central passageway that is configured to receive coiled tubing therethrough;
(b) one or more magnets that are configured to generate a magnetic field that extends at least partially across the central passageway; and
(c) one or more sensors are configured to detect one or more properties of the magnetic field and to detect one or more properties of the magnetic field as the coiled tubing approaches, moves through and moves away from the central passageway.

13. The coiled-tubing inspection tool of claim 12, wherein the one or more sensors are configured to detect a change in the one or more properties of the magnetic field as a damaged portion of the coiled tubing moves towards, through and away from the central passageway.

14. The coiled-tubing inspection tool of claim 12, wherein the one or more sensors and the one or more magnets are arranged in a first sensor array.

15. The coiled-tubing inspection tool of claim 12, wherein the one or more sensors and the one or more magnets are arranged in a first sensor array and a second sensor array and wherein the first sensor array and the second sensor array are spaced apart along a central passageway of the coiled-tubing inspection tool.

16. The coiled-tubing inspection tool of claim 12, wherein the one or more sensors and one or more magnets are arranged in a first sensor array, a second sensor array and a third sensor array.

17. The coiled-tubing inspection tool of claim 16, wherein the first sensor array is in a lateral arrangement or a vertical arrangement.

18. The coiled-tubing inspection tool of claim 17, wherein the second sensor array is in a lateral arrangement or a vertical arrangement.

19. The coiled-tubing inspection tool of claim 15, wherein the first sensor array and the second sensor array are in an offset arrangement.

20. The coiled-tubing inspection tool of claim 15, wherein the body is made of a non-magnetic material.

21. The coiled-tubing inspection tool of claim 15, wherein the coiled tubing is substantially centralized when proximal to the coiled-tubing inspection tool.

22. A method for detecting a damaged section of coiled tubing, the method comprising steps of:
(a) generating a magnetic field within the pressurized section of the well;
(b) exposing the coiled tubing to the magnetic field while moving the coiled tubing through the pressurized section of the well; and
(c) detecting any changes in the magnetic field as the coiled tubing approaches, moves through and moves away from the magnetic field.

23. The method of claim 22, further comprising a step of filtering the detected changes in the magnetic field.

24. The method of claim 22, further comprising a step of positioning an inspection device that performs steps (a), (b) and (c) within a pressure-containment section of a well.

25. The method of claim 24, further comprising a step of measuring one or more properties of the well prior to steps (a), (b) and (c).

26. The method of claim 22, further comprising a step of substantially centralizing the coiled tubing within the magnetic field.
